(19) United States
(12) Patent Application Publication
(10) Pub. No.: US 2017/0171627 A1
(43) Pub. Date: Jun. 15, 2017

(54) METHOD AND ELECTRONIC DEVICE FOR PUSHING A VIDEO OVER A CDN

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Peng CANG, Tianjing (CN)

(21) Appl. No.: 15/246,191

(22) Filed: Aug. 24, 2016

Related U.S. Application Data
(63) Continuation of application No. PCT/CN2016/088957, filed on Jul. 6, 2016.

(30) Foreign Application Priority Data
Dec. 15, 2015 (CN) 201510953132.0

(51) Int. Cl. H04N 21/472; H04L 29/08; H04N 21/84; H04N 21/482; H04N 21/466

(52) U.S. Cl. CPC H04N 21/47202; H04N 21/4826; H04N 21/4668; H04N 21/4828; H04N 21/84; H04L 67/26

(57) ABSTRACT

Disclosures are a method and electronic device for pushing a video over a CDN, where the method includes: searching for a currently set number of CDN nodes which are at the shortest spatial distances as target nodes; transmitting a list retrieval request to each target node so that the target node returns a video content list of buffered video contents upon reception of the list retrieval request; integrating the video content lists returned by the target nodes into a list of popular video contents upon reception of the video content lists; and displaying the list of popular video contents for playing for a user on demand.

### CROSS REFERENCE TO RELATED APPLICATIONS

This application is a continuation of International Application No. PCT/CN2016/088957, filed on Jul. 6, 2016, which is based upon and claims priority to Chinese Patent Application No. 201510953132.0, filed with the Chinese Patent Office on Dec. 15, 2015 and entitled “Method, system, and device for pushing a video over a CDN”, which is hereby incorporated by reference in its entirety.

### TECHNICAL FIELD

The present disclosure relates to the field of video-on-demand technologies, and particularly to a method and electronic device for pushing a video over a CDN, storage medium.

### BACKGROUND

At present a Content Delivery Network (CDN) has been widely applied to deployment of video servers, where if more CDN nodes are deployed, then more users will be covered by the CDN, and there will be shorter spatial distances between the users and the nodes. If video contents to be played for a user on demand are available from a CDN node at the shortest spatial distance from the user, then the video contents will be played at the highest speed. Since there are limited storage spaces of the CDN nodes, all the video contents may not be buffered, so a delivery control center of the CDN will deliver popular videos which are frequently played on demand to all the CDN nodes for buffering to thereby guarantee an experience of the popular videos to be played, and deliver unpopular videos which are infrequently played on demand to a few CDN nodes for buffering to thereby make reasonable use of resources so as to avoid the resources from being overloaded.

However the inventors of the disclosure have identified during making of the disclosure that in this delivery solution, if an unpopular video is to be played for a user on demand, then the unpopular video will be retrieved from a CDN node in which the unpopular video is stored, and relayed to a CDN node at the shortest spatial distance for playing, but usually the unpopular video to be played for the user on demand at will may be very likely to be played for only several minutes, and then closed because it is not interesting to the user, which may add to a scheduling burden on the CDN, and also degrade an experience of watching the video to be played.

### SUMMARY

According to a first aspect of the embodiments of the disclosure, there is provided a method for pushing a video over a CDN, the method including:

searching for a currently set number of CDN nodes which are at the shortest spatial distances as target nodes;

transmitting a list retrieval request to each target node so that the target node returns a video content list of buffered video contents upon reception of the list retrieval request;

integrating the video content lists returned by the target nodes into a list of popular video contents upon reception of the video content lists; and

displaying the list of popular video contents for playing for a user on demand.

According to a second aspect of the embodiments of the disclosure, there is provided a electronic device for pushing a video over a CDN, the system including:

at least one processor; and

a memory communicably connected with the at least one processor for storing instructions executable by the at least one processor, wherein execution of the instructions by the at least one processor causes the at least one processor:

to search for a currently set number of CDN nodes which are at the shortest spatial distances as target nodes;

to transmit a list retrieval request to each target node so that the target node returns a video content list of buffered video contents upon reception of the list retrieval request;

to receive and integrate the video content lists returned by the target nodes into a list of popular video contents; and

to display the list of popular video contents for playing for a user on demand

According to a third aspect of the embodiments of the disclosure, there is provided a non-transitory computer-readable storage medium storing executable instructions that, when executed by an electronic device with a touch-sensitive display, cause the electronic device:

to search for a currently set number of CDN nodes which are at the shortest spatial distances as target nodes;

to transmit a list retrieval request to each target node so that the target node returns a video content list of buffered video contents upon reception of the list retrieval request;

to receive and integrate the video content lists returned by the target nodes into a list of popular video contents; and

to display the list of popular video contents for playing for a user on demand.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 illustrates a flow chart of an implementation of a method for pushing a video over a CDN in accordance with some embodiments.

FIG. 2 illustrates a structural block diagram of an implementation of device for pushing a video over a CDN in accordance with some embodiments;

FIG. 3 illustrates a structural block diagram of an implementation of electronic device for pushing a video over a CDN in accordance with some embodiment;

FIG. 4 illustrates a structural block diagram of an implementation of non-transitory computer-readable storage medium in accordance with some embodiment.

### DETAILED DESCRIPTION

Various exemplary embodiments of the disclosure will be described below in details with reference to the drawings. It shall be noted that unless stated otherwise, relative arrangements of components and steps, numeral expressions, and values, which are set forth in these embodiments will not limit the scope of the disclosure.

The following description of at least one exemplary embodiment is merely illustrative indeed, but not intended to limit the disclosure and its applications or uses in any way.

Techniques, methods, and devices known to those skilled in the art may not be discussed in details, but shall be construed as a part of the specification if appropriate.

Any particular values throughout the examples illustrated and discussed here shall be constructed as merely illustrative, but not intended to be limiting. Accordingly there may be different values in other examples of the exemplary embodiments.

It shall be noted that like reference numerals and symbols will refer to like elements throughout the drawings, so if some element is defined in one of the drawings, then it will not be further discussed in subsequent drawings.

In order to address such a problem that an unpopular video played for a user on demand at will is usually watched for a short period of time, thus increasing a scheduling burden on the CDN, an embodiment of the disclosure provides a method for pushing a video over a CDN as illustrated in FIG. 1, where the method includes the following steps:

The step S1 is to search for a currently set number of CDN nodes which are at the shortest spatial distances as target nodes.

For example, this action can be triggered by a user logging onto a corresponding client application, refreshing the corresponding client application, viewing a list of popular video contents, presetting a search periodicity, etc., where the list of popular video contents is updated each time it is triggered.

The currently set number can be preset, and can be modified by the user as needed, or can be adjusted automatically.

The step S2 is to transmit a list retrieval request to each target node so that the target node returns a video content list of buffered video contents upon reception of the list retrieval request.

Correspondingly the target node can make a statistic of the buffered video contents, create the corresponding video content list, and update in real time the video content list as a delivery control center delivers and deletes the video contents to thereby respond rapidly upon reception of the list retrieval request so as to speed up retrieval of a list of popular video contents as described below.

The step S3 is to integrate the received video content lists returned by the target nodes into a list of popular video contents upon reception of the video content lists.

Particularly in the step S3, all the received video content lists returned by all the target nodes are further integrated into the list of popular video contents upon reception of the video content lists, which means that the flow waits for reception thereof at latest until the list of popular video contents is updated next time.

However in order to avoid the list of popular video contents from being updated due to a failure of communication with some target node, particularly in the step S3, if the video content list returned by the target node is received within a preset period of time after the list retrieval request is transmitted, then the video content lists received within the preset period of time will be integrated into the list of popular video contents, which means that the flow waits for updating of the list of popular video contents at latest until the preset period of time elapses, where the list of popular video contents is updated each time using the video content lists received within the preset period of time after the list retrieval request is transmitted, and the video content lists received after the preset period of time are ignored. If the video content lists returned by all the target nodes are received within the preset period of time, then the video content lists returned by all the target nodes will be integrated into the list of popular video contents immediately upon reception thereof without further waiting until the preset period of time elapses.

The step S4 is to display the list of popular video contents for playing for a user on demand.

In this step, the list of popular video contents is displayed particularly on a terminal of the user.

As can be apparent, the method for pushing a video over a CDN according to the embodiment of the disclosure can push the lists of video contents buffered in several CDN nodes which are the closest, to the user as the list of popular video contents to thereby raise the probability that the video contents of interest to the user are played from the list of popular video contents to the user on demand at will so as to lower the probability that an unpopular video buffered in a CDN node which is far away is played for the user on demand at will; and since all the video contents in the list of popular video contents can be retrieved from one or more CDN nodes at the shortest spatial distances, the scheduling burden on the CDN can be alleviated significantly in the method according to the embodiments of the disclosure.

In order to enable the user to browse conveniently the list of popular video contents so as to improve the experience of the user, in a particular implementation of the embodiment of the disclosure, the list of popular video contents can be displayed in the step S4 above in the following steps:

The step A is to split the list of popular video contents into lists of categorized video contents corresponding to respective category tags according to category identifiers of the video contents.

Correspondingly the video content lists returned by the target nodes shall include the category identifiers of the respective categories of video contents, including, for example, movies, teleplays, variety shows, cartoons, sporting, music, documentaries, etc., where the teleplays and the movies can be subdivided into comedies, love stories, suspense stories, Europe and U.S.A. stories, mainland stories, Hong Kong and Taiwan stories, Japanese and Korean stories, and other categories, so the same video contents may be provided with a number of category tabs.

The list of popular video contents can be split according to the category identifiers of the video contents in the step A in the following steps:

The step A1 is to obtain the category tags preset in a category display;

To create the lists of categorized video contents corresponding to the respective category tags; and

To add the categories of video contents in the list of popular video contents to the corresponding lists of categorized video contents according to the category identifiers of the video contents.

The step A2 is to display the corresponding lists of categorized video contents under the respective category tags.

In order to enable the method according to the embodiment of the disclosure to support an application in which the currently set number is modified as needed in reality, in a particular implementation of the embodiment of the disclosure, the method can further includes: updating the currently set number to a user input set number upon reception of the user input set number; and the method can further include: counting at a preset temporal periodicity the number of times that the video contents from the list of popular video contents are played for the user on demand in the last temporal periodicity; and if the number of times is less than a preset number of times, and the currently set number is less than a set number upper limit, then increasing the currently set number at a preset adjustment step which can be set to 1, where an initial value of the currently set number is preferably set to 1 to thereby speed up updating of the list of popular video contents so as to provide the best experience of the user.

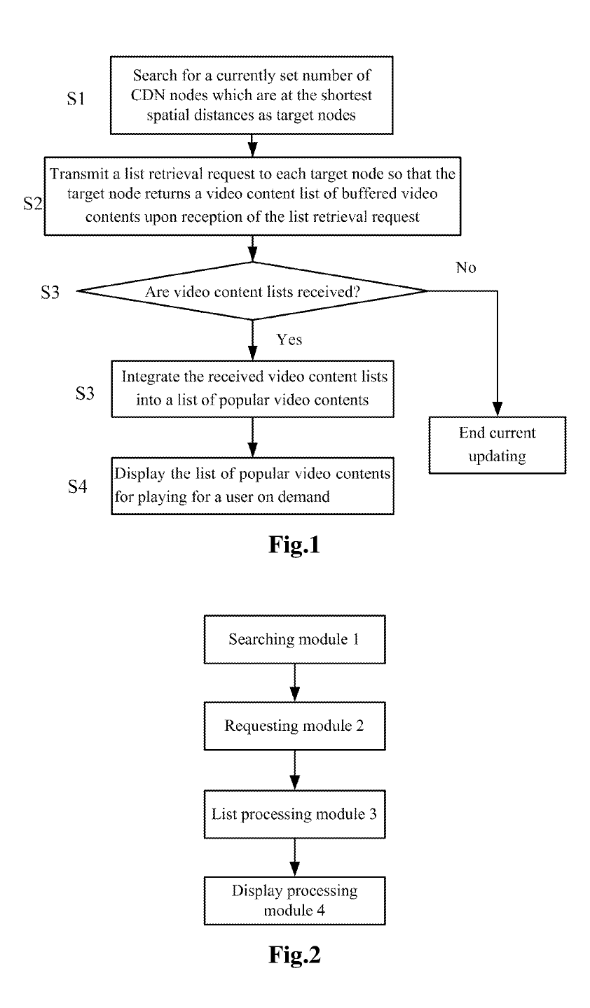

Further to the video pushing method above, an embodiment of the disclosure further provides a system for pushing a video over a CDN, which can perform the method according to the embodiment of the disclosure, as illustrated in FIG. 2, where the video pushing system includes a searching module 1, a requesting module 2, a list processing module 3, and a display processing module 4, where the searching module 1 is configured to search for a currently set number of CDN nodes which are at the shortest spatial distances as target nodes; the requesting module 2 is configured to transmit a list retrieval request to each target node so that the target node returns a video content list of buffered video contents upon reception of the list retrieval request; the list processing module 3 is configured to receive and integrate the video content lists returned by the target nodes into a list of popular video contents; and the display processing module 4 is configured to display the list of popular video contents for playing for a user on demand.

The list processing module 3 can be further configured, if the video content list returned by the target node is received within a preset period of time after the list retrieval request is transmitted, to integrate the video content lists received within the preset period of time into the list of popular video contents.

The display processing module 4 can be further configured to split the list of popular video contents into lists of categorized video contents corresponding to respective category tags according to category identifiers of the video contents, and to display the corresponding lists of categorized video contents under the respective category tags.

The display processing module 4 can be further configured to obtain the category tags preset in a category display; to create the lists of categorized video contents corresponding to the respective category tags; and to add the categories of video contents in the list of popular video contents to the corresponding lists of categorized video contents according to the category identifiers of the video contents.

The system according to the embodiment of the disclosure can further include a number updating module (not illustrated) configured to receive a user input preset number, and to update the currently set number to the user input preset number; and/or to count at a preset temporal periodicity the number of times that the video contents from the list of popular video contents are played for the user on demand in the last temporal periodicity; and if the number of times is less than a preset number of times, and the currently set number is less than a set number upper limit, to increase the currently set number at a preset adjustment step.

An embodiment of the disclosure further provides an electronic device according to the embodiment of the disclosure, the electronic device according to the embodiment of the disclosure can alleviate a scheduling burden over a CDN while videos are being played for users on demand The device can be any device capable of playing a video, e.g., a handset, a TV set, a tablet computer, or another user terminal.

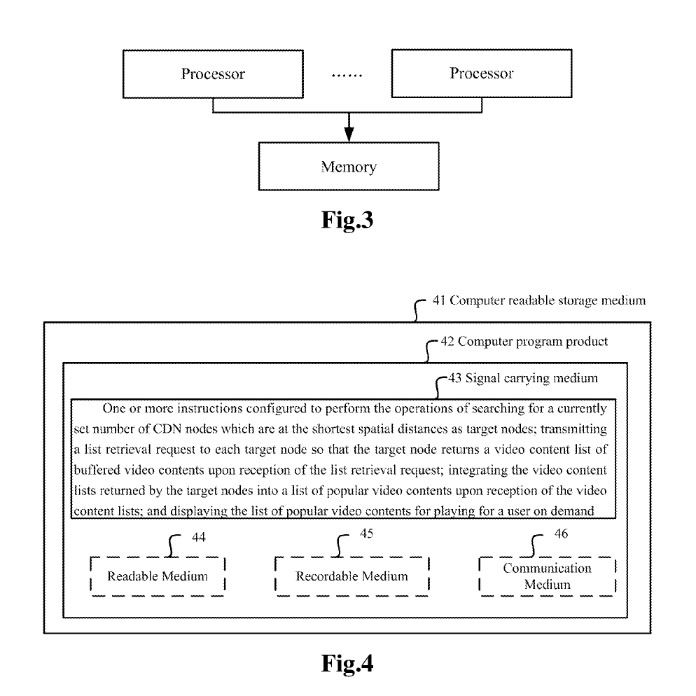

As illustrated in FIG. 3, the electronic device according to the embodiment of the disclosure includes: at least one processor; and a memory communicably connected with the at least one processor for storing instructions executable by the at least one processor, wherein execution of the instructions by the at least one processor causes the at least one processor:

to search for a currently set number of CDN nodes which are at the shortest spatial distances as target nodes;

to transmit a list retrieval request to each target node so that the target node returns a video content list of buffered video contents upon reception of the list retrieval request;

to receive and integrate the video content lists returned by the target nodes into a list of popular video contents; and

to display the list of popular video contents for playing for a user on demand.

Where execution of the instructions by the at least one processor further causes the at least one processor, if the video content list returned by the target node is received within a preset period of time after the list retrieval request is transmitted, to integrate the video content lists received within the preset period of time into the list of popular video contents.

Where execution of the instructions by the at least one processor further causes the at least one processor to split the list of popular video contents into lists of categorized video contents corresponding to respective category tags according to category identifiers of the video contents, and to display the corresponding lists of categorized video contents under the respective category tags.

Where execution of the instructions by the at least one processor further causes the at least one processor: to obtain the category tags preset in a category display; to create the lists of categorized video contents corresponding to the respective category tags; and to add the categories of video contents in the list of popular video contents to the corresponding lists of categorized video contents according to the category identifiers of the video contents.

Wherein execution of the instructions by the at least one processor further causes the at least one processor: to receive a user input preset number, and to update the currently set number to the user input preset number; and/or to count at a preset temporal periodicity the number of times that the video contents from the list of popular video contents are played for the user on demand in the last temporal periodicity; and if the number of times is less than a preset number of times, and the currently set number is less than a set number upper limit, to increase the currently set number at a preset adjustment step.

An embodiment of the disclosure provides a non-transitory computer-readable storage medium storing executable instructions that, when executed by an electronic device with a touch-sensitive display, cause the electronic device: to search for a currently set number of CDN nodes which are at the shortest spatial distances as target nodes; to transmit a list retrieval request to each target node so that the target node returns a video content list of buffered video contents upon reception of the list retrieval request; to receive and integrate the video content lists returned by the target nodes into a list of popular video contents; and to display the list of popular video contents for playing for a user on demand.

As illustrated in FIG. 4, a computer readable storage medium 41 stores thereon a computer program product 42 which can include any combination of one or more readable mediums, e.g., a signal carrying medium 43, a readable medium 44, a recordable medium 45, a communication medium 46, etc., and the signal carrying medium 43 stores therein one or more instructions executed by the electronic device cause the electronic device: to search for a currently set number of CDN nodes which are at the shortest spatial distances as target nodes; to transmit a list retrieval request to each target node so that the target node returns a video content list of buffered video contents upon reception of the list retrieval request; to receive and integrate the video content lists returned by the target nodes into a list of popular video contents; and to display the list of popular video contents for playing for a user on demand.

Where execution of the instructions by the electronic device further causes the electronic device: if the video content list returned by the target node is received within a preset period of time after the list retrieval request is transmitted, to integrate the video content lists received within the preset period of time into the list of popular video contents.

Where execution of the instructions by the electronic device further causes the electronic device: to split the list of popular video contents into lists of categorized video contents corresponding to respective category tags according to category identifiers of the video contents, and to display the corresponding lists of categorized video contents under the respective category tags.

Where execution of the instructions by the electronic device further causes the electronic device: to obtain the category tags preset in a category display; to create the lists of categorized video contents corresponding to the respective category tags; and to add the categories of video contents in the list of popular video contents to the corresponding lists of categorized video contents according to the category identifiers of the video contents.

Where execution of the instructions by the electronic device further causes the electronic device: to receive a user input preset number, and to update the currently set number to the user input preset number; and/or to count at a preset temporal periodicity the number of times that the video contents from the list of popular video contents are played for the user on demand in the last temporal periodicity; and if the number of times is less than a preset number of times, and the currently set number is less than a set number upper limit, to increase the currently set number at a preset adjustment step.

The respective embodiments in the specification have been described progressively, each of the embodiments has been focused on its differences from the other embodiments, and the description of their commonalities can be applied to each other. However those skilled in the art shall appreciate that the respective embodiments can be applied separately or in combination as needed. Moreover the embodiments of the system correspond to the embodiments of the method, so the embodiments of the system have been described in brevity, and reference can be made to the description of the corresponding components in the embodiments of the method for details of those components in the embodiments of the system. The embodiments of the system have been described above merely by way of an example, and the modules described as separate components may or may not be physically separate.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The embodiments of the apparatuses described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for pushing a video over a CDN, the method comprising:
searching, by an electronic device, for a currently set number of CDN nodes which are at the shortest spatial distances as target nodes;
transmitting, by the electronic device, a list retrieval request to each target node so that the target node returns a video content list of buffered video contents upon reception of the list retrieval request;
integrating, by the electronic device, the video content lists returned by the target nodes into a list of popular video contents upon reception of the video content lists; and
displaying, by the electronic device, the list of popular video contents for playing for a user on demand.

2. The method according to claim 1, wherein integrating, by the electronic device, the video content lists returned by the target nodes into the list of popular video contents upon reception of the video content lists comprises:
if the video content list returned by the target node is received within a preset period of time after the list retrieval request is transmitted, then integrating, by the electronic device, the video content lists received within the preset period of time into the list of popular video contents.

3. The method according to claim 1, wherein displaying, by the electronic device, the list of popular video contents comprises:
splitting, by the electronic device, the list of popular video contents into lists of categorized video contents corresponding to respective category tags according to category identifiers of the video contents; and
displaying, by the electronic device, the corresponding lists of categorized video contents under the respective category tags.

4. The method according to claim 3, wherein splitting, by the electronic device, the list of popular video contents according to the category identifiers of the video contents comprises:
obtaining, by the electronic device, the category tags preset in a category display;
creating, by the electronic device, the lists of categorized video contents corresponding to the respective category tags; and
adding, by the electronic device, the categories of video contents in the list of popular video contents to the corresponding lists of categorized video contents according to the category identifiers of the video contents.

5. The method according to claim 1, wherein the method further comprises:
updating, by the electronic device, the currently set number to a user input preset number upon reception of the user input preset number; and/or
counting, by the electronic device, at a preset temporal periodicity the number of times that the video contents from the list of popular video contents are played for the user on demand in the last temporal periodicity; and
if the number of times is less than a preset number of times, and the currently set number is less than a set number upper limit, to increasing, by the electronic device, the currently set number at a preset adjustment step.

6. An electronic device for pushing a video over a CDN, the electronic device comprising:
at least one processor; and
a memory communicably connected with the at least one processor for storing instructions executable by the at least one processor, wherein execution of the instructions by the at least one processor causes the at least one processor:
to search for a currently set number of CDN nodes which are at the shortest spatial distances as target nodes;
to transmit a list retrieval request to each target node so that the target node returns a video content list of buffered video contents upon reception of the list retrieval request;
to receive and integrate the video content lists returned by the target nodes into a list of popular video contents; and
to display the list of popular video contents for playing for a user on demand

7. The electronic device according to claim 6, wherein execution of the instructions by the at least one processor further causes the at least one processor, if the video content list returned by the target node is received within a preset period of time after the list retrieval request is transmitted, to integrate the video content lists received within the preset period of time into the list of popular video contents.

8. The electronic device according to claim 6, wherein execution of the instructions by the at least one processor further causes the at least one processor to split the list of popular video contents into lists of categorized video contents corresponding to respective category tags according to category identifiers of the video contents, and to display the corresponding lists of categorized video contents under the respective category tags.

9. The electronic device according to claim 8, wherein execution of the instructions by the at least one processor further causes the at least one processor:
to obtain the category tags preset in a category display;
to create the lists of categorized video contents corresponding to the respective category tags; and
to add the categories of video contents in the list of popular video contents to the corresponding lists of categorized video contents according to the category identifiers of the video contents.

10. The electronic device according to claim 6, wherein execution of the instructions by the at least one processor further causes the at least one processor:
to receive a user input preset number, and to update the currently set number to the user input preset number; and/or to count at a preset temporal periodicity the number of times that the video contents from the list of popular video contents are played for the user on demand in the last temporal periodicity; and if the number of times is less than a preset number of times, and the currently set number is less than a set number upper limit, to increase the currently set number at a preset adjustment step.

11. A non-transitory computer-readable storage medium storing executable instructions that, when executed by an electronic device with a touch-sensitive display, cause the electronic device:
to search for a currently set number of CDN nodes which are at the shortest spatial distances as target nodes;
to transmit a list retrieval request to each target node so that the target node returns a video content list of buffered video contents upon reception of the list retrieval request;
to receive and integrate the video content lists returned by the target nodes into a list of popular video contents; and
to display the list of popular video contents for playing for a user on demand.

12. The storage medium according to claim 11, wherein execution of the instructions by the electronic device further causes the electronic device:
if the video content list returned by the target node is received within a preset period of time after the list retrieval request is transmitted, to integrate the video content lists received within the preset period of time into the list of popular video contents.

13. The storage medium according to claim 11, wherein execution of the instructions by the electronic device further causes the electronic device:
to split the list of popular video contents into lists of categorized video contents corresponding to respective category tags according to category identifiers of the video contents, and to display the corresponding lists of categorized video contents under the respective category tags.

14. The storage medium according to claim 13, wherein execution of the instructions by the electronic device further causes the electronic device:
to obtain the category tags preset in a category display;
to create the lists of categorized video contents corresponding to the respective category tags; and
to add the categories of video contents in the list of popular video contents to the corresponding lists of categorized video contents according to the category identifiers of the video contents.

15. The storage medium according to claim 11, wherein execution of the instructions by the electronic device further causes the electronic device:
to receive a user input preset number, and to update the currently set number to the user input preset number; and/or to count at a preset temporal periodicity the number of times that the video contents from the list of popular video contents are played for the user on demand in the last temporal periodicity; and if the number of times is less than a preset number of times, and the currently set number is less than a set number upper limit, to increase the currently set number at a preset adjustment step.
